(19) United States
(12) Patent Application Publication
(10) Pub. No.: US 2025/0015259 A1
(43) Pub. Date: Jan. 9, 2025

(54) PROCESS FOR PRODUCING SILICON-CONTAINING MATERIALS

(71) Applicant: Wacker Chemie AG, Munich (DE)

(72) Inventors: Christoph DRÄGER, München (DE); Stefan HAUFE, Neubiberg (DE)

(73) Assignee: Wacker Chemie AG, Munich (DE)

(21) Appl. No.: 18/713,207

(22) PCT Filed: Dec. 2, 2021
(86) PCT No.: PCT/EP2021/083993

§ 371 Date: May 24, 2024

(51) Int. Cl. H01M 4/134; C01B 33/037; C09K 13/02; H01M 4/02; H01M 4/38; H01M 10/0525

(52) U.S. Cl. CPC H01M 4/134; C01B 33/037; C09K 13/02; H01M 4/386; H01M 10/0525; C01P 2006/12; H01M 2004/027

(57) ABSTRACT

A process for producing etched silicon-containing materials includes a first step and a second step. In the first step, silicon is deposited in the pores and on the surface of porous particles by way of thermal decomposition of silicon precursors on the porous particles, forming silicon-containing materials. In the second step, some of the deposited silicon of the silicon-containing materials is removed by etching-off.

The invention relates to a process for utilizing silicon-containing materials by removing excess silicon from particle surfaces, and to the use of the thus obtained silicon-containing materials as active materials for anodes of lithium-ion batteries.

As storage media for electric power, lithium-ion batteries are currently the most practical electrochemical energy stores with the highest energy densities. Lithium-ion batteries are primarily used in the field of portable electronics, for tools and also for electrically driven means of transport, such as bicycles, scooters or automobiles. Graphitic carbon is currently widely used as active material for the negative electrode (“anode”) of corresponding batteries. A disadvantage, however, is the relatively low electrochemical capacity of such graphitic carbons, which is theoretically at most 372 mAh per gram of graphite and therefore corresponds to only about one tenth of the electrochemical capacity theoretically achievable with lithium metal. Alternative active materials for the anode use an addition of silicon, as described for example in EP 1730800 B1, U.S. Pat. No. 10,559,812 B2, U.S. Pat. No. 10,819,400 B2, or EP 3335262 B1. Silicon forms binary electrochemically active alloys with lithium, which enable very high electrochemically achievable lithium contents of up to 3579 mAh per gram of silicon [M. Obrovac, V. L. Chevrier Chem. Rev. 2014, 114, 11444].

The intercalation and deintercalation of lithium ions in silicon is associated with the disadvantage of an accompanying very significant change in volume, which can reach up to 300% in the case of complete intercalation. Such changes in volume subject the silicon-containing active material to severe mechanical loading, as a result of which the active material may eventually break apart. This process, also referred to as electrochemical grinding, leads to a loss of electrical contacting in the active material and in the electrode structure and thus to the lasting, irreversible loss of capacity of the electrode.

Furthermore, the surface of the silicon-containing active material reacts with constituents of the electrolyte with continuous formation of passivating protective layers (Solid Electrolyte Interphase; SEI). The components formed are no longer electrochemically active. The lithium bound therein is no longer available to the system, which leads to a pronounced continuous loss of capacity of the battery. Due to the extreme change in volume of the silicon during the charging/discharging process of the battery, the SEI regularly breaks up, meaning that further, as yet unoccupied surfaces of the silicon-containing active material are exposed, which are then subject to further SEI formation. Since the amount of mobile lithium in the complete cell, which corresponds to the usable capacity, is limited by the cathode material, it is increasingly consumed, and the capacity of the cell drops after just a few cycles to an extent that is unacceptable from a performance standpoint.

The decrease in capacity over the course of multiple charging and discharging cycles is also referred to as fading or continuous loss of capacity and is generally irreversible.

As active materials for anodes of lithium-ion batteries, a series of silicon-carbon composite particles have been described, in which the silicon is incorporated into porous carbon particles starting from gaseous or liquid precursors.

For example, U.S. Pat. No. 10,147,950 B2 describes the deposition of silicon from monosilane SiH₄ in a porous carbon in a tube furnace or comparable furnace types at elevated temperatures of 300° C. to 900° C., preferably with agitation of the particles, by a CVD (“chemical vapor deposition”) or PE-CVD (“plasma-enhanced chemical vapor deposition”) process. This uses a mixture of 2 mol % monosilane with nitrogen as inert gas. The low concentration of the silicon precursor in the gas mixture leads to very long reaction times. Furthermore, U.S. Pat. No. 10,147,950 B2 discloses a plurality of possible combinations of different temperature ranges of 300° C. to 900° C. with different pressure ranges of 0.01 to 100 bar for carrying out the deposition of silicon on and in porous starting materials.

U.S. Pat. No. 10,424,786 B1 describes an analogous procedure, in which the silicon precursors are introduced as a mixture with inert gas at an overall pressure of 1.013 bar. WO2012/097969 A1 describes the deposition of ultrafine silicon particles in the range of 1 to 20 nm by heating silanes as silicon precursor on porous carbon carriers at 200° C. to 950° C., the silane being diluted with an inert gas in order to prevent agglomeration of the deposited silicon particles or the formation of thick layers, the deposition being effected in a pressure range of 0.1 to 5 bar.

Motevalian et al, Ind. Eng. Chem. Res. 2017, 56, 14995, describe the deposition of silicon layers at elevated pressure, but not in the presence of a porous matrix. Again, the silicon precursor used, in this case monosilane SiH₄, is present only at a low concentration of at most 5 mol % in the overall gas volume.

The processes described above have a range of serious disadvantages. The silicon precursor is usually used at low absolute and partial pressures and hence at low concentration, this necessitating long reaction times in order to achieve high silicon proportions in the silicon-containing material, since thick Si layers are otherwise formed on the particle exterior. These thick silicon layers are detrimental in that, in contact with electrolyte and in the course of cycling, they lead to a high degree of structuring of the particle surface in combination with constant regeneration of the SEI. In addition, the optimal adjustment of the process parameters requires precise knowledge of all reaction parameters, which usually have to be determined empirically. In addition, the porous matrices used exhibit a certain variation range with respect to their pore and particle size distribution, with the result that it is not possible to rule out overinfiltration with silicon precursor that leads to thick silicon layers. Thick Si layers are also formed if, for reasons of productivity, the infiltration takes place at relatively high concentration of the Si precursor and/or relatively high temperature. In the course of these empirical studies, the production of batches of material with disadvantageous product properties is unavoidable.

Against this background, the object was to find a process for utilizing batches of material with disadvantageous product properties which makes it possible to use silicon-containing materials as active material in anodes of lithium-ion batteries having a high cycling stability.

The invention provides a process for producing etched silicon-containing materials, in which, in a first step, silicon is deposited in the pores and on the surface of porous particles by way of thermal decomposition of silicon precursors on the porous particles, forming silicon-containing materials, and, in a second step, some of the deposited silicon of the silicon-containing materials is removed by etching-off.

Surprisingly, the object was essentially achieved by a process in which the silicon applied in excess to the particle surface is removed from the surface in a controlled manner via an etching treatment of the overinfiltrated particles.

The disadvantageous effect of the particle structurings caused by the thick Si layers during cycling is surprisingly overcome by the process according to the invention.

The silicon-containing material preferably consists of silicon-containing particles. These may for example be obtained by thermally decomposing one or more silicon precursors in the presence of one or more porous particles, whereby silicon is deposited in pores and on the surface of the porous particles.

The silicon-containing material may be produced in any desired reactors customary for the deposition of silicon from silicon precursors. Preference is given to reactors selected from the group comprising fluidized-bed reactors, rotary tube furnaces, which may be oriented in any desired arrangement from horizontal through vertical, and fixed-bed reactors, which may be operated as open or closed systems, for example as pressure reactors. Particular preference is given to reactors which enable the porous particles and the silicon-containing material formed during the deposition to be mixed homogeneously with the silicon precursors. This is advantageous for the most homogeneous possible deposition of silicon in pores and on the surface of the porous particles. Most preferred reactors are fluidized-bed reactors, rotary tube furnaces or pressure reactors, in particular fluidized-bed reactors or pressure reactors.

The silicon precursor used contains at least one reactive component that can react to give silicon under the selected conditions, for example thermal treatment. The reactive component is preferably selected from the group containing silicon-hydrogen compounds such as monosilane SiH₄, disilane Si₂H₆ and higher linear, branched or else cyclic homologs, neopentasilane Si₅H₁₂, cyclohexasilane Si₆H₁₂, chlorine-containing silanes, such as trichlorosilane HSiCl₃, dichlorosilane H₂SiCl₂, chlorosilane H₃SiCl, tetrachlorosilane SiCl₄, hexachlorodisilane Si₂Cl₆, and higher linear, branched or else cyclic homologs, such as 1,1,2,2-tetrachlorodisilane C₁₂HSi—SiHCl₂, chlorinated and partially chlorinated oligo- and polysilanes, methylchlorosilanes, such as trichloromethylsilane MeSiCl₃, dichlorodimethylsilane Me₂SiCl₂, chlorotrimethylsilane Me₃SiCl, tetramethylsilane Me₄Si, dichloromethylsilane MeHSiCl₂, chloromethylsilane MeH₂SiCl, methylsilane MeH₃Si, chlorodimethylsilane Me₂HSiCl, dimethylsilane Me₂H₂Si, trimethylsilane Me₃SiH, or else mixtures of the silicon compounds described.

Moreover, the reactive components may additionally also contain further reactive constituents, such as dopants based for example on compounds containing boron, nitrogen, phosphorus, arsenic, germanium, iron or else nickel. The dopants are preferably selected from the group comprising ammonia NH₃, diborane B₂H₆, phosphane PH₃, germane GeH₄, arsine AsH₃, iron pentacarbonyl Fe(CO)₄ and nickel tetracarbonyl Ni(CO)₄.

Further reactive constituents that may be present in the reactive component include hydrogen or else hydrocarbons selected from the group containing aliphatic hydrocarbons having 1 to 10 carbon atoms, preferably 1 to 6 carbon atoms, such as methane, ethane, propane, butane, pentane, isobutane, hexane, cyclopropane, cyclobutane, cyclopentane, cyclohexane, cycloheptane; unsaturated hydrocarbons having 1 to 10 carbon atoms such as ethene, acetylene, propene or butene, isoprene, butadiene, divinylbenzene, vinylacetylene, cyclohexadiene, cyclooctadiene, cyclic unsaturated hydrocarbons, such as cyclopropene, cyclobutene, cyclopentene, cyclohexene, cyclohexadiene, cyclopentadiene, dicyclopentadiene or norbornadiene, aromatic hydrocarbons, such as benzene, toluene, p-, m-, o-xylene, styrene (vinylbenzene), ethylbenzene, diphenylmethane or naphthalene, further aromatic hydrocarbons, such as phenol, o-, m-, p-cresol, cymene, nitrobenzene, chlorobenzene, pyridine, anthracene or phenanthrene, myrcene, geraniol, thioterpineol, norbornane, borneol, isoborneol, bornane, camphor, limonene, terpinene, pinene, pinane, carene, phenol, aniline, anisole, furan, furfural, furfuryl alcohol, hydroxymethylfurfural, bishydroxymethylfuran and mixed fractions containing a multiplicity of such compounds, such as from natural gas condensates, petroleum distillates or coke oven condensates, mixed fractions from the product streams of a fluid catalytic cracker (FCC), steam cracker or a Fischer-Tropsch synthesis plant, or more generally hydrocarbon-containing material streams from wood, natural gas, petroleum and coal processing.

The process for Si deposition is preferably carried out in an inert gas atmosphere, for example in a nitrogen or argon atmosphere.

The process may otherwise be carried out in the conventional manner, as is customary for the deposition of silicon from silicon precursors, where necessary with routine adjustments that are usual for those skilled in the art.

The porous particles for the process according to the invention are preferably selected from the group containing amorphous carbon in the form of hard carbon, soft carbon, mesocarbon microbeads, natural graphite or synthetic graphite, single- and multi-walled carbon nanotubes and graphene, oxides such as silicon dioxide, aluminum oxide, silicon-aluminum mixed oxides, magnesium oxide, lead oxides and zirconium oxide, carbides such as silicon carbides and boron carbides, nitrides such as silicon nitrides and boron nitrides; and other ceramic materials, such as may be described by the following component formula:

AlₐB_{b}C_{c}Mg_{d}NₑO_{f}Si_{g} where 0≤a, b, c, d, e, f, g≤1, with at least two coefficients a to g>0 and a*3+b*3+c*4+d*2+g*4≥e*3+f*2.

The ceramic materials may for example be binary, ternary, quaternary, quinary, senary or septenary compounds. Preference is given to ceramic materials with the following component formulae:

non-stoichiometric boron nitrides BN_{z} where z=0.2 to 1,
non-stoichiometric carbon nitrides CN_{z} where z=0.1 to 4/3,
boron carbonitrides BₓCN_{z} where x=0.1 to 20 and z=0.1 to 20, where x*3+4≥z*3,
boron nitridooxides BN_{z}Oᵣ where z=0.1 to 1 and r=0.1 to 1, where 3≥r*2+z*3,
boron carbonitridooxides BₓCN_{z}Oᵣ where x=0.1 to 2, z=0.1 to 1 and r=0.1 to 1, where: x*3+4≥r*2+z*3,
silicon carbooxides SiₓCO_{z} where x=0.1 to 2 and z=0.1 to 2, where x*4+4≥z*2,
silicon carbonitrides SiₓCN_{z} where x=0.1 to 3 and z=0.1 to 4, where x*4+4≥z*3,
silicon borocarbonitrides Si_{w}BₓCN_{z} where w=0.1 to 3, x=0.1 to 2 and z=0.1 to 4, where w*4+x*3+4≥z*3,
silicon borocarbooxides Si_{w}BₓCO_{z} where w=0.10 to 3, x=0.1 to 2 and z=0.1 to 4, where w*4+x*3+4≥z*2,
silicon borocarbonitridooxides SiᵥB_{w}CNₓO_{z} where v=0.1 to 3, w=0.1 to 2, x=0.1 to 4 and z=0.1 to 3, where v*4+w*3+4>x*3+z*2 and
aluminum borosilicocarbonitridooxides AlᵤBᵥSiₓCN_{w}O_{z} where u=0.1 to 2, v=0.1 to 2, w=0.1 to 4, x=0.1 to 2 and z=0.1 to 3, where u*3+v*3+x*4+4≥w*3+z*2.

The porous particles preferably have a density, determined by helium pycnometry, of 0.1 to 7 g/cm³ and particularly preferably of 0.3 to 3 g/cm³. This is advantageous for increasing the gravimetric capacity (mAh/cm³) of lithium-ion batteries.

Preferably used as porous particles are amorphous carbons, silicon dioxide, boron nitride, silicon carbide and silicon nitride or else mixed materials based on these materials; particular preference is given to the use of amorphous carbons, boron nitride and silicon dioxide.

The porous particles have a volume-weighted particle size distribution with diameter percentiles d₅₀ of preferably ≥0.5 μm, particularly preferably ≥1.5 μm and most preferably ≥2 μm. The diameter percentiles d₅₀ are preferably ≤20 μm, particularly preferably ≤12 μm and most preferably ≤8 μm.

The volume-weighted particle size distribution of the porous particles is preferably between the diameter percentiles d₁₀≥0.2 μm and d₉₀≤20.0 μm, particularly preferably between d₁₀≥0.4 μm and d₉₀≤15.0 μm and most preferably between d₁₀≥0.6 μm to d₉₀≤12.0 μm.

The porous particles have a volume-weighted particle size distribution with diameter percentiles d₁₀ of preferably ≤10 μm, particularly preferably ≤5 μm, especially preferably ≤3 μm and most preferably ≤2 μm. The diameter percentiles d₁₀ are preferably ≥0.2 μm, particularly preferably ≥0.5 and most preferably ≥1 μm.

The porous particles have a volume-weighted particle size distribution with diameter percentiles d₉₀ of preferably ≥4 μm and particularly preferably ≥8 μm. The diameter percentiles d₉₀ are preferably ≤18 μm, particularly preferably ≤15 and most preferably ≤13 μm.

The volume-weighted particle size distribution of the porous particles has a width d₉₀−d₁₀ of preferably ≤15.0 μm, more preferably ≤12.0 μm, particularly preferably ≤10.0 μm, especially preferably ≤8.0 μm and most preferably ≤4.0 μm.

The volume-weighted particle size distribution of the silicon-containing materials producible by the process according to the invention has a width d₉₀−d₁₀ of preferably ≥0.6 μm, particularly preferably >0.8 μm and most preferably ≥1.0 μm.

The volume-weighted particle size distribution of the porous particles is determinable according to ISO 13320 by static laser scattering using the Mie model with the Horiba LA 950 measuring device with ethanol as the dispersing medium for the porous particles.

The particles may for example be in isolated or agglomerated form. The porous particles are preferably non-aggregated and preferably non-agglomerated. Aggregated generally means that in the course of the production of the porous particles, primary particles are initially formed and coalesce and/or primary particles are linked to one another, for example via covalent bonds, and in this way form aggregates. Primary particles are generally isolated particles. Aggregates or isolated particles can form agglomerates. Agglomerates are a loose accumulation of aggregates or primary particles that are linked to one another for example via van der Waals interactions or hydrogen bonds. Agglomerated aggregates can easily be split back into aggregates again by standard kneading and dispersing processes. Aggregates can be broken down into the primary particles only partially by such processes, if at all. The presence of porous particles in the form of aggregates, agglomerates or isolated particles can be visualized for example using conventional scanning electron microscopy (SEM). By contrast, static light scattering methods for determining particle size distributions or particle diameters of matrix particles cannot distinguish between aggregates and agglomerates.

The porous particles may have any desired morphology, i.e. for example may be splintered, flaky, spherical or else needle-shaped, with splintered or spherical particles being preferred. The morphology may for example be characterized by the sphericity ψ or the sphericity S.

According to Wadell's definition, the sphericity ψ is the ratio of the surface area of a sphere of equal volume to the actual surface area of a body. In the case of a sphere, y has the value 1. According to this definition, the porous particles for the process according to the invention have a sphericity ψ of preferably 0.3 to 1.0, particularly preferably of 0.5 to 1.0 and most preferably of 0.65 to 1.0.

The sphericity S is the ratio of the circumference of an equivalent circle with the same area A as the projection of the particle projected onto a surface and the measured circumference U of this projection: S=2\sqrt{πA}/U. In the case of an ideally circular particle, S would have the value 1. For the porous particles for the process according to the invention, the sphericity S is in the range of preferably 0.5 to 1.0 and particularly preferably of 0.65 to 1.0, based on the percentiles S₁₀ to S₉₀ of the sphericity number distribution. The sphericity S is measured for example on the basis of micrographs of individual particles with an optical microscope or, in the case of particles <10 μm, preferably with a scanning electron microscope by graphical evaluation using image analysis software, such as ImageJ.

The porous particles preferably have a gas-accessible pore volume of ≥0.2 cm³/g, particularly preferably ≥0.6 cm³/g and most preferably ≥1.0 cm³/g. This is conducive to obtaining high-capacity lithium-ion batteries. The gas-accessible pore volume was determined by gas sorption measurements with nitrogen according to DIN 66134.

The porous particles are preferably open-pored. Open-pored generally means that pores are connected to the surface of particles, for example via channels, and can preferably exchange mass with the environment, in particular exchange gaseous compounds. This can be demonstrated by gas sorption measurements (analysis according to Brunauer, Emmett and Teller, “BET”), i.e. the specific surface area. The porous particles have specific surface areas of preferably ≥100 m²/g, particularly preferably ≥500 m²/g, especially preferably ≥1000 m²/g and most preferably ≥1500 m²/g. The BET surface area is determined according to DIN 66131 (with nitrogen).

The pores of the porous particles may have any desired diameter, i.e. may generally be in the range of macropores (above 50 nm), mesopores (2-50 nm) and micropores (smaller than 2 nm). The porous particles may be used in any desired mixtures of different pore types. Preference is given to using porous particles having less than 30% macropores, based on the total pore volume, particularly preferably porous particles without macropores and very particularly preferably porous particles having at least 50% pores having an average pore diameter of less than 5 nm. Very particularly preferably, the porous particles exclusively have pores having a pore diameter of less than 2 nm (method of determination: Pore size distribution according to BJH (gas adsorption) in accordance with DIN 66134 in the mesopore range and according to Horvath-Kawazoe (gas adsorption) in accordance with DIN 66135 in the micropore range; the pore size distribution in the macropore range is evaluated by mercury porosimetry according to DIN ISO 15901-1).

Preference is given to porous particles having gas-inaccessible pore volumes of less than 0.3 cm³/g and particularly preferably less than 0.15 cm³/g. This also makes it possible to increase the capacity of the lithium-ion batteries. The gas-inaccessible pore volume can be determined using the following formula:

Gas-inaccessible pore volume=1/pure-material density−1/skeletal density.

The pure-material density is a theoretical density of the porous particles, based on the phase composition or the density of the pure substance (density of the material as if it had no closed porosity). Pure-material density data can be found by those skilled in the art for example in the Ceramic Data Portal of the National Institute of Standards (NIST, https://srdata.nist.gov/CeramicDataPortal/scd). For example, the pure-material density of silicon oxide is 2.20 g/cm³, that of boron nitride is 2.25 g cm³, that of silicon nitride is 3.44 g/cm³ and that of silicon carbide is 3.21 g/cm³. The skeletal density is the actual density of the porous particles (gas-accessible) as determined by helium pycnometry.

For clarification, it should be noted that the porous particles are different from the silicon-containing material. The porous particles act as starting material for producing the silicon-containing material. Preferably, there is generally no silicon, more particularly no silicon obtained by deposition of silicon precursors, located in the pores of the porous particles and on the surface of the porous particles.

The silicon-containing material obtainable by means of deposition of silicon in pores and on the surface of the porous particles by the process according to the invention has a volume-weighted particle size distribution with diameter percentiles d₅₀ preferably in a range of 0.5 to 20 μm. The d₅₀ value is preferably at least 1.5 μm, and particularly preferably at least 2.0 μm. The diameter percentiles d₅₀ are preferably at most 13 μm and particularly preferably at most 8 μm.

The volume-weighted particle size distribution of the silicon-containing material is preferably between the diameter percentiles d₁₀≥0.2 μm and d₉₀≤20.0 μm, particularly preferably between d₁₀≥0.4 μm and d₉₀≤15.0 μm and most preferably between d₁₀≥0.6 μm to d₉₀≤12.0 μm.

The silicon-containing material has a volume-weighted particle size distribution with diameter percentiles d₁₀ of preferably ≤10 μm, particularly preferably ≤5 μm, especially preferably ≤3 μm and most preferably ≤1 μm. The diameter percentiles d₁₀ are preferably ≥0.2 μm, particularly preferably ≥0.4 μm and most preferably ≥0.6 μm.

The silicon-containing material has a volume-weighted particle size distribution with diameter percentiles d_{A3,i,j,k} of preferably ≥5 μm and particularly preferably ≥10 μm. The diameter percentiles d₉₀ are preferably ≤20 μm, particularly preferably ≤15 μm and most preferably ≤12 μm.

The volume-weighted particle size distribution of the silicon-containing material has a width d₉₀−d₁₀ of preferably ≤15.0 μm, particularly preferably ≤12.0 μm, more preferably ≤10.0 μm, especially preferably ≤8.0 μm and most preferably ≤4.0 μm. The volume-weighted particle size distribution of the silicon-containing material has a width d₉₀−d₁₀ of preferably ≥0.6 μm, particularly preferably ≥0.8 μm and most preferably ≥1.0 μm.

The silicon-containing material is preferably in the form of particles. The particles may be in isolated or agglomerated form. The silicon-containing material is preferably non-aggregated and preferably non-agglomerated. The terms isolated, agglomerated and non-aggregated have already been defined further above with respect to the porous particles. The presence of silicon-containing materials in the form of aggregates or agglomerates can be visualized for example using conventional scanning electron microscopy (SEM).

The silicon-containing material may have any desired morphology, i.e. for example may be splintered, flaky, spherical or else needle-shaped, with splintered or spherical particles being preferred.

According to Wadell's definition, the sphericity ψ is the ratio of the surface area of a sphere of equal volume to the actual surface area of a body. In the case of a sphere, y has the value 1. According to this definition, the silicon-containing materials obtainable by the process according to the invention have a sphericity ψ of preferably 0.3 to 1.0, particularly preferably of 0.5 to 1.0 and most preferably of 0.65 to 1.0.

The sphericity S is the ratio of the circumference of an equivalent circle with the same area A as the projection of the particle projected onto a surface and the measured circumference U of this projection: S=2\sqrt{πA}/U. In the case of an ideally circular particle, S would have the value 1. For the silicon-containing materials obtainable by the process according to the invention, the sphericity S is in the range of preferably 0.5 to 1.0 and particularly preferably of 0.65 to 1.0, based on the percentiles S₁₀ to S₉₀ of the sphericity number distribution. The sphericity S is measured for example on the basis of micrographs of individual particles with an optical microscope or, in the case of particles smaller than 10 μm, preferably with a scanning electron microscope by graphical evaluation using image analysis software, such as ImageJ.

The cycling stability of lithium-ion batteries can be further increased via the morphology, the material composition, in particular the specific surface area or the internal porosity of the silicon-containing material.

The silicon-containing material preferably contains 10% to 90% by weight, more preferably 20% to 80% by weight, particularly preferably 30% to 60% by weight and especially preferably 40% to 50% by weight of porous particles, based on the total weight of the silicon-containing material.

The silicon-containing material preferably contains 10% to 90% by weight, more preferably 20% to 80% by weight, particularly preferably 30% to 60% by weight and especially preferably 40% to 50% by weight of silicon obtained via deposition from the silicon precursor, based on the total weight of the silicon-containing material (determination preferably by means of elemental analysis, such as ICP-OES).

If the porous particles contain silicon compounds, for example in the form of silicon dioxide, the abovementioned % by weight figures can be determined for the silicon obtained via deposition from the silicon precursor by subtracting the mass of silicon of the porous particles determined by elemental analysis from the mass of silicon of the silicon-containing material determined by elemental analysis and dividing the result by the mass of the silicon-containing material.

The volume of silicon present in the silicon-containing material and obtained via deposition from the silicon precursor results from the mass fraction of the silicon obtained via deposition from the silicon precursor in the total mass of the silicon-containing material divided by the density of silicon (2.336 g/cm³).

The pore volume P of the silicon-containing materials results from the sum of gas-accessible and gas-inaccessible pore volumes. The Gurwitsch gas-accessible pore volume of the silicon-containing material is determinable by gas sorption measurements with nitrogen according to DIN 66134.

The gas-inaccessible pore volume of the silicon-containing material is determinable using the formula:

Gas-inaccessible pore volume=1/pure-material density-1/skeletal density.

The pure-material density of a silicon-containing material is a theoretical density that can be calculated from the sum of the theoretical pure-material densities of the components present in the silicon-containing material, multiplied by their respective weight-related percentage of the total material. By way of example, for a silicon-containing material in which silicon is deposited on a porous particle, this results in:

pure-material density=theoretical pure-material density of silicon*proportion of silicon in % by weight+theoretical pure-material density of the porous particles*proportion of the porous particles in % by weight.

The pore volume P of the silicon-containing materials is in the range of 0% to 400% by volume, preferably in the range of 100% to 350% by volume and particularly preferably in the range of 200% to 350% by volume, based on the volume of the silicon present in the silicon-containing material and obtained from the deposition from the silicon precursor.

The porosity present in the silicon-containing material may be both gas-accessible and gas-inaccessible. The ratio of the volume of gas-accessible to gas-inaccessible porosity of the silicon-containing material can generally be in the range of 0 (no gas-accessible pores) to 1 (all pores are gas-accessible). The ratio of the volume of gas-accessible to gas-inaccessible porosity of the silicon-containing material is preferably in the range of 0 to 0.8, particularly preferably in the range of 0 to 0.3 and especially preferably 0 to 0.1.

The pores of the silicon-containing material may have any desired diameters, for example in the range of macropores (>50 nm), mesopores (2-50 nm) and micropores (<2 nm). The silicon-containing material may also contain any desired mixtures of different pore types. Preferably, the silicon-containing material contains at most 30% of macropores, based on the total pore volume; particular preference is given to a silicon-containing material without macropores and very particular preference is given to a silicon-containing material having at least 50% of pores based on the total pore volume with an average pore diameter of less than 5 nm. Especially preferably, the silicon-containing material exclusively has pores with a diameter of at most 2 nm.

The silicon-containing material has silicon structures which, in at least one dimension, have structure sizes of preferably at most 1000 nm, more preferably less than 100 nm, particularly preferably less than 5 nm (determination method: scanning electron microscopy (SEM) and/or high-resolution transmission electron microscopy (HR-TEM)).

The silicon-containing material preferably comprises silicon layers having a layer thickness of less than 1000 nm, more preferably less than 100 nm, particularly preferably less than 5 nm (determination method: scanning electron microscopy (SEM) and/or high-resolution transmission electron microscopy (HR-TEM)). The silicon-containing material may also contain silicon in the form of particles. Silicon particles have a diameter of preferably at most 1000 nm, more preferably less than 100 nm, particularly preferably less than 5 nm (determination method: scanning electron microscopy (SEM) and/or high-resolution transmission electron microscopy (HR-TEM)). The data about the silicon particles preferably relates here to the diameter of the circumference of the particles in the microscope image.

Furthermore, the silicon deposited from the silicon precursor in the silicon-containing material may contain dopants, for example selected from the group containing Li, Fe, Al, Cu, Ca, K, Na, S, Cl, Zr, Ti, Pt, Ni, Cr, Sn, Mg, Ag, Co, Zn, B, P, Sb, Pb, Ge, Bi, rare earths or combinations thereof. Lithium and/or tin are preferred. The content of dopants in the silicon-containing material is preferably at most 1% by weight and particularly preferably at most 100 ppm based on the total weight of the silicon-containing material, determinable by ICP-OES.

The silicon-containing material generally exhibits a surprisingly high stability under compressive load and/or shear stress. The compressive load stability and the shear stability of the silicon-containing material are apparent for example from the fact that the silicon-containing material has only slight changes, if any, in its porous structure in the SEM under compressive load (for example during electrode compaction) and shear stress (for example during electrode preparation).

The silicon-containing material may optionally contain additional elements, such as carbon. Preference is given to carbon in the form of thin layers with a layer thickness of at most 1 μm, preferably less than 100 nm, particularly preferably less than 5 nm and very particularly preferably less than 1 nm (determinable via SEM or HR-TEM). The carbon layers may be present here both in the pores and on the surface of the silicon-containing material. The sequence of different layers in the silicon-containing material is also arbitrary. Thus, there may firstly be a layer, on the porous particles, of a further material different from the porous particles, such as carbon, and thereupon a silicon layer or a layer of silicon particles. There may also in turn be a layer, on the silicon layer or on the layer of silicon particles, of a further material which may be different from the material of the porous particles or identical to said material, irrespective of whether a further layer of a material different from the material of the porous particles is present between the porous particles and the silicon layer or the layer consisting of silicon particles.

The silicon-containing material preferably contains ≤50% by weight, particularly preferably ≤40% by weight and especially preferably ≤20% by weight of additional elements. The silicon-containing material preferably contains ≥1% by weight, particularly preferably ≥3% by weight and especially preferably ≥2% by weight of additional elements. The figures in % by weight refer to the total weight of the silicon-containing material. In an alternative embodiment, the silicon-containing material does not contain any additional elements.

In the second step, some of the deposited silicon of the silicon-containing materials is removed by etching-off. Coarse silicon, also referred to as excess silicon, is removed here. The fine silicon is desired and remains on and in the etched silicon-containing materials. Preferably, the amount of excess silicon in the deposited silicon after the etching is less than 3% by weight, particularly preferably less than 1% by weight, especially preferably less than 0.1% by weight.

Fine and coarse silicon in a sample can be determined by means of TGA measurements via the reaction of silicon with oxygen to form SiO₂. The distinguishability of different silicon species can be explained by the fact that thin silicon layers show higher reactivity to oxygen than thick layers or Si particles. This has the result that in TGA measurements thin Si layers react (increase in mass) even at low temperatures (400-650° C.) and thick layers/coarse silicon structures show a reaction only at temperatures of more than 700° C. Ideally, silicon-containing composites that are to be used as anode active materials show no increase in mass in a TGA measurement under oxygen-containing atmosphere at temperatures of more than 800° C. This method further allows determination of the content of elemental silicon. Silicon previously oxidized and passivated by contact with air no longer takes part in the reaction and is thus not taken into account in the TGA measurements.

Calculating the coarse silicon present requires the residual mass (mres) from the TGA method and the mass difference (mdiff) that results from oxidation of the coarse silicon. Using the molar mass of O₂ (32 g/mol) and the molar mass of SiO₂ (60.08 g/mol), the proportion of coarse silicon in the deposited silicon can then be calculated via the following formula:

$$coarse Si , \% = mdiff * \frac{60.08 \frac{g}{mol}}{32 \frac{g}{mol} * mres} * 100 \%$$

If it is then desired to calculate the excess silicon of the material, then the proportion of coarse silicon must be multiplied by the proportion of deposited silicon of the material.

Silicon can be removed from surfaces industrially in many ways. Liquid or gaseous etching medium is particularly suitable for this. For liquid etching medium, on the one hand the wet-chemical route based on HF under oxidizing conditions (for example as a mixture with HNO₃ and acetic acid—HNA, CP4) has become established, on the other hand however so has the wet-chemical treatment with basic solutions, for example solutions containing KOH, tetramethylammonium hydroxide (TMAH), NaOH, LiOH, CsOH, NH₄OH, Mg(OH)₂, Ca(OH)₂, Ba(OH)₂, ethylenediamine (EDP). These wet-chemical etching procedures may be carried out at room temperature (25° C.), but also at elevated temperature below the boiling point of the solutions in order to accelerate the reaction. In addition to increasing the temperature, energy may also be introduced into the system via microwave or ultrasonic treatment. Etching processes below room temperature (<25° C.) are likewise conceivable.

In addition to the wet-chemical etching processes, etching processes via the gas phase are also known. XeF₂ or SF₆ for example may be used here as gaseous etching medium, with a plasma being induced.

The etching may be performed either iteratively (etching medium in deficiency) with monitoring of the content of coarse silicon, or by etching tailored to the amount of coarse silicon (calculated amount of etching medium).

After the etching, the etched silicon-containing materials are preferably washed with washing medium, preferably water.

After the washing, the etched silicon-containing materials are preferably separated from the washing medium and dried.

The etched silicon-containing material preferably has a specific surface area of at most 80 m²/g, particularly preferably less than 30 m²/g, and especially preferably less than 10 m²/g.

The BET surface area is determined according to DIN 66131 (with nitrogen). Thus, when using the silicon-containing material as active material in anodes for lithium-ion batteries, SEI formation can be reduced and the initial Coulomb efficiency can be increased.

The invention further provides for the use of the etched silicon-containing material as active material in anode materials for anodes of lithium-ion batteries and the use of such anodes for producing lithium-ion batteries.

The anode material is preferably based on a mixture comprising the etched silicon-containing material obtainable by the process according to the invention, one or more binders, optionally graphite as further active material, optionally one or more further electrically conducting components and optionally one or more additives.

By using further electrically conducting components in the anode material, the contact resistances within the electrode and between the electrode and current collector can be reduced, which improves the current-carrying capacity of the lithium-ion battery according to the invention. Preferred further electrically conducting components are for example conductive carbon black, carbon nanotubes or metallic particles, such as copper.

The anode material preferably contains 0% to 95% by weight, particularly preferably 0% to 40% by weight and most preferably 0% to 25% by weight of one or more further electrically conducting components, based on the total weight of the anode material.

The etched silicon-containing material may be present in the anodes for lithium-ion batteries at an extent of preferably 5% to 100% by weight, particularly preferably 30% to 100% by weight and most preferably 60% to 100% by weight, based on all of the active material present in the anode material.

Preferred binders are polyacrylic acid or the alkali metal salts thereof, in particular the lithium or sodium salts, polyvinyl alcohols, cellulose or cellulose derivatives, polyvinylidene fluoride, polytetrafluoroethylene, polyolefins, polyimides, in particular polyamide-imides, or thermoplastic elastomers, in particular ethylene-propylene-diene terpolymers. The alkali metal salts, in particular the lithium or sodium salts, of the aforementioned binders are also particularly preferred. All or preferably a proportion of the acid groups of a binder may be in the form of salts. The binders have a molar mass of preferably 100 000 to 1 000 000 g/mol. Mixtures of two or more binders may also be used.

The graphite used may generally be natural or synthetic graphite. The graphite particles preferably have a volume-weighted particle size distribution between the diameter percentiles d₁₀>0.2 μm and d₉₀<200 μm.

Examples of additives are pore formers, dispersants, leveling agents or dopants, for example elemental lithium.

Preferred formulations for the anode material contain preferably 5% to 95% by weight of the silicon-containing material, 0% to 90% by weight of further electrically conducting components, 0% to 90% by weight of graphite, 0% to 25% by weight of binder and 0% to 80% by weight of additives, where the figures in % by weight refer to the total weight of the anode material and the proportions of all constituents of the anode material add up to 100% by weight.

The constituents of the anode material are preferably processed into an anode ink or paste in a solvent, preferably selected from the group comprising water, hexane, toluene, tetrahydrofuran, N-methylpyrrolidone, N-ethylpyrrolidone, acetone, ethyl acetate, dimethyl sulfoxide, dimethylacetamide and ethanol, and mixtures of these solvents, preferably using rotor-stator machines, high-energy mills, planetary kneaders, agitator bead mills, vibrating plates or ultrasonic devices.

The anode ink or paste has a pH of preferably 2 to 8.5 (determined at 20° C., for example with the WTW pH 340i PH meter with SenTix RJD probe).

The anode ink or paste may for example be applied by doctor blade to a copper foil or another current collector. Other coating processes, such as rotational coating (spin coating), roller coating, dipping or slot-die coating, painting or spraying, may also be used according to the invention.

Before the copper foil is coated with the anode material according to the invention, the copper foil may be treated with a commercially available primer, for example based on polymer resins or silanes. Primers can lead to an improvement in the adhesion to the copper, but themselves generally have virtually no electrochemical activity.

The anode material is generally dried to constant weight. The drying temperature is guided by the components used and the solvent employed. It is preferably between 20° C. and 300° C. The layer thickness, i.e. the dry layer thickness of the anode coating, is preferably 2 to 500 μm.

Finally, the electrode coatings may be calendered in order to set a defined porosity. The electrodes thus produced preferably have porosities of 15% to 85%, which can be determined by mercury porosimetry according to DIN ISO 15901-1. Preferably 25% to 85% of the pore volume that can be determined in this way is provided here by pores that have a pore diameter of 0.01 to 2 μm.

The invention further provides lithium-ion batteries comprising a cathode, an anode that contains the etched silicon-containing material, two electrically conducting connections to the electrodes, a separator and an electrolyte with which the separator and the two electrodes are impregnated, and a housing accommodating the parts mentioned.

In the context of this invention, the term lithium-ion battery also encompasses cells. Cells generally comprise a cathode, an anode, a separator and an electrolyte. In addition to one or more cells, lithium-ion batteries preferably additionally contain a battery management system. Battery management systems are generally used to control batteries, for example using electronic circuits, in particular for detecting the state of charge, for deep discharge protection or overcharge protection.

Preferred cathode materials used according to the invention may be lithium cobalt oxide, lithium nickel oxide, lithium nickel cobalt oxide (doped or undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate or lithium vanadium oxides.

The separator is generally an electrically insulating, ion-permeable membrane, preferably made of polyolefins, for example polyethylene (PE) or polypropylene (PP), or polyester or corresponding laminates. Alternatively, as is customary in battery manufacture, the separator may consist of or be coated with glass or ceramic materials. As is known, the separator separates the first electrode from the second electrode and thus prevents electronically conducting connections between the electrodes (short circuit).

The electrolyte is preferably a solution containing one or more lithium salts (=conductive salt) in an aprotic solvent. Conductive salts are preferably selected from the group containing lithium hexafluorophosphate, lithium hexafluoroarsenate, lithium perchlorate, lithium tetrafluoroborate, lithium imides, lithium methides, lithium trifluoromethanesulfonate LiCF₃SO₃, lithium bis(trifluoromethanesulfonimide) LiN(CF₃SO₂)₂ and lithium borates. The concentration of the conductive salt, based on the solvent, is preferably between 0.5 mol/l and the solubility limit of the salt in question. Particularly preferably, it is 0.8 to 1.2 mol/l.

Solvents used are preferably cyclic carbonates, propylene carbonate, ethylene carbonate, fluoroethylene carbonate, dimethyl carbonate, diethyl carbonate, ethyl methyl carbonate, dimethoxyethane, diethoxyethane, tetrahydrofuran, 2-methyltetrahydrofuran, gamma-butyrolactone, dioxolane, acetonitrile, organic carbonic acid esters or nitriles, individually or as mixtures thereof.

The electrolyte preferably contains a film former, such as vinylene carbonate or fluoroethylene carbonate. As a result, it is possible to achieve a significant improvement in the cycling stability of the anodes containing the etched silicon-containing material obtained by the process according to the invention. This is mainly attributed to the formation of a solid electrolyte interphase on the surface of active particles. The proportion of the film former in the electrolyte is preferably between 0.1% and 20.0% by weight.

In order to match the actual capacities of the electrodes of a lithium-ion cell to one another as optimally as possible, it is advantageous to balance out, in terms of their absolute capacity, the materials for the positive and negative electrodes. Of particular importance in this context is the fact that, in the first or initial charging/discharging cycle of secondary lithium ion cells (known as activation), a covering layer is formed on the surface of the electrochemically active materials in the anode. This covering layer is referred to as “solid electrolyte interphase” (SEI) and generally consists primarily of electrolyte decomposition products and a certain amount of lithium, which is accordingly no longer available for further charging/discharging reactions.

The thickness and composition of the SEI depends on the type and the quality of the anode material used and the electrolyte solution used.

In the case of graphite, the SEI is particularly thin. On graphite, there is a loss of typically 5% to 35% of the mobile lithium in the first charging step. Correspondingly, the reversible capacity of the battery also decreases.

In the case of anodes with the etched silicon-containing active material obtained by the process according to the invention, in the first charging step there is a loss of mobile lithium of preferably at most 30%, particularly preferably at most 20% and most preferably at most 10%, which is well below the values described in the prior art, such as in U.S. Pat. No. 10,147,950 B1.

All substances and materials utilized for the production of such lithium-ion batteries, as described above, are known. The production of the parts of such batteries and their assembly to form batteries are performed in accordance with the processes known within the field of battery manufacture.

The etched silicon-containing material obtained by the process according to the invention is characterized by significantly improved electrochemical behavior and results in lithium-ion batteries having high volumetric capacities and excellent performance properties. The etched silicon-containing material obtained by the process according to the invention is permeable to lithium ions and electrons, and therefore enables charge transport. The SEI in lithium-ion batteries can be reduced to a large extent with the etched silicon-containing material obtained by the process according to the invention. In addition, due to the design of the etched silicon-containing material obtained by the process according to the invention, the SEI becomes detached from the surface of the active material at least to a much lesser extent, if at all. All of this leads to a high cycling stability of corresponding lithium-ion batteries, the anodes of which contain the etched silicon-containing material obtained by the process according to the invention.

The examples which follow serve for further elucidation of the invention described here.

The following analytical methods and instruments were used for characterization:

### Scanning Electron Microscopy (SEM/EDX):

The microscope analyses were carried out with a Zeiss Ultra 55 scanning electron microscope and an energy-dispersive Oxford X-Max 80N x-ray spectrometer. Before analysis, the samples were subjected to vapor deposition of carbon with a Safematic Compact Coating Unit 010/HV in order to prevent charging phenomena. The cross sections of the silicon-containing materials were produced with a Leica TIC 3X ion cutter at 6 kV.

### Inorganic Analysis/Elemental Analysis:

The C contents reported in the examples were determined with a Leco CS 230 analyzer; for determination of O and, where appropriate, N or H contents, a Leco TCH-600 analyzer was used. The qualitative and quantitative determination of other reported elements was carried out by ICP (inductively coupled plasma) emission spectrometry (Optima 7300 DV, Perkin Elmer). To this end, the samples were subjected to acid digestion (HF/HNO₃) in a microwave (Microwave 3000, from Anton Paar). The ICP-OES determination is guided by ISO 11885 “Water quality-Determination of selected elements by inductively coupled plasma optical emission spectrometry (ICP-OES) (ISO 11885:2007); German version of EN ISO 11885:2009”, which is used for analysis of acidic, aqueous solutions (for example acidified drinking water, wastewater and other water samples and aqua regia extracts of soils and sediments).

### Particle Size Determination:

The particle size distribution was determined in the context of this invention according to ISO 13320 by static laser scattering using a Horiba LA 950. In the preparation of the samples, particular care must be taken in dispersing the particles in the measurement solution in order to ensure that what is measured is the size of individual particles and not that of agglomerates. The particles were dispersed in ethanol for the measurement. To this end, prior to measurement the dispersion was treated if required with 250 W ultrasound for 4 min in a Hielscher UIS250v laboratory ultrasound instrument with LS24d5 sonotrode.

### BET Surface Area Measurement:

The specific surface area of the materials was measured via gas adsorption with nitrogen using a Sorptomatic 199090 instrument (Porotec) or SA-9603MP instrument (Horiba) by the BET method (determination according to DIN ISO 9277:2003-05 using nitrogen).

### Skeletal Density:

The skeletal density, i.e. the density of the porous solid based on the volume exclusively of the externally gas-accessible pore spaces, was determined by He pycnometry according to DIN 66137-2.

### Gas-Accessible Pore Volume:

The Gurwitsch gas-accessible pore volume was determined by gas sorption measurements with nitrogen according to DIN 66134.

### Thermogravimetry (TGA) and Determination of Coarse Silicon:

The reactivity of the powders to oxygen was determined by means of TGA measurements in pure oxygen in a temperature window of 25-1000° C. using a heating rate of 5 K/min.

The following materials and instruments were used when carrying out the experimental examples:

The SiH₄ used, of quality 4.0, was obtained from Linde GmbH.

### Porous Particles Used:

Porous carbon particles having the following properties were used:

BET surface area: 2140 m²/g

Gurvich PV: 1.01 cm³/g

### EXAMPLES

### Comparative Example 1: Production of an Overinfiltrated Si/C Composite

### Production of Silicon-Containing Materials Using Monosilane SiH₄ as Silicon Precursor.

In Phase 1, an autoclave was filled with the amount 10.04 g of porous material and closed. In Phase 2, the autoclave was first evacuated. Subsequently, an amount of 16.6 g of SiH₄ was applied with a pressure of 15.5 bar. In Phase 3, the autoclave was heated to a temperature of 420° C. over the course of 2.5 hours, and in Phase 4 the temperature was maintained for 60 minutes. In Phase 5, the autoclave cooled down to room temperature over the course of 12 hours. A pressure of 37.6 bar remained in the autoclave after the cooling. In Phase 6, the pressure in the autoclave was reduced to 1 bar and then purging was performed five times with nitrogen, five times with lean air having an oxygen content of 5%, five times with lean air having an oxygen content of 10% and then five times with air. In Phase 7, an amount of 22 g of a silicon-containing material was isolated in the form of a black, fine solid. The silicon content was 57.5% by weight.

### Example 2: (BeS06956) Removal of Excess Silicon by Etching with an Amount of Sodium Hydroxide Solution Tailored to the Coarse Silicon Content

0.2 g of NaOH in 99.8 ml of demineralized water was initially charged into a 250 ml round-bottom flask and 9 g of the material from Example 1 were added gradually. The suspension obtained was stirred at 40° C. in a water bath for 10 min and then passed through a paper filter (filter paper 413, VWR). The powder thus obtained was then suspended in 200 ml of water and isolated by filtration once again. This procedure was repeated until the filtrate obtained had a pH of 8.0. The resulting filter cake was dried to constant weight at 80° C. in a drying cabinet. The properties of the treated Si composite can be found in Table 1 (excess silicon 0.0% by weight, BET surface area 64 m²/g). The silicon content was 48.0% by weight. % by weight

### Example 3, 4 and 6: Electrochemistry of Comparative Example 1 and Example 2, and Comparative Example 5

### Electrochemical Characterization of the Silicon-Containing Materials Used as Active Materials in Anodes of Lithium-Ion Batteries:

29.71 g of polyacrylic acid (dried to constant weight at 85° C.; Sigma-Aldrich, Mw ˜450 000 g/mol) and 756.6 g of deionized water were agitated by means of a shaker (290 l/min) for 2.5 h until complete dissolution of the polyacrylic acid. Lithium hydroxide monohydrate (Sigma-Aldrich) was added to the solution a little at a time until the pH was 7.0 (measured using WTW pH 340i PH meter and SenTix RJD probe). The solution was then mixed by means of a shaker for a further 4 h.

3.87 g of the neutralized polyacrylic acid solution and 0.96 g of graphite (Imerys, KS6L C) were initially charged into a 50 ml vessel and mixed in a planetary mixer (SpeedMixer, DAC 150 SP) at 2000 rpm. Subsequently, 3.40 g of the silicon-containing materials from Example 1 or 2 were stirred in at 2000 rpm for 1 min. Subsequently, 1.21 g of an 8-percent conductive carbon black dispersion and 0.8 g of deionized water were added and incorporated at 2000 rpm in the planetary mixer. This was followed by dispersion in a dissolver at 3000 rpm for 30 min at a constant 20° C. The ink was degassed again in the planetary mixer at 1500 rpm for 5 min.

The finished dispersion was then applied to a copper foil having a thickness of 0.03 mm (Schlenk Metallfolien, SE-Cu58) using a film-drawing frame with a gap clearance of 0.1 mm (Erichsen, model 360). The anode coating thus produced was then dried at 50° C. and 1 bar air pressure for 60 min. The average basis weight of the dry anode coating was 1.9 mg/cm² and the coating density 0.9 g/cm³.

The electrochemical studies were carried out on a button cell (CR2032 type, Hohsen Corp.) in a two-electrode arrangement. The electrode coating was used as counterelectrode or negative electrode (Dm=15 mm); a coating based on lithium-nickel-manganese-cobalt oxide 6:2:2 having a content of 94.0% and average basis weight of 15.9 mg/cm² (obtained from SEI) was used as working electrode or positive electrode (Dm=15 mm). A glass fiber filter paper (Whatman, GD Type D) saturated with 60 μl of electrolyte was used as the separator (Dm=16 mm). The electrolyte used consisted of a 1.0 molar solution of lithium hexafluorophosphate in a 1:4 (v/v) mixture of fluoroethylene carbonate and diethyl carbonate. The cell was assembled in a glovebox (<1 ppm H₂O, O₂); the water content in the dry matter of all components used was below 20 ppm.

Electrochemical testing was carried out at 20° C. The cell was charged by the cc/cv (constant current/constant voltage) method with a constant current of 12 mA/g (corresponding to C/10) in the first cycle and of 60 mA/g (corresponding to C/2) in the subsequent cycles and, on attainment of the voltage limit of 4.2 V, at constant voltage until the current fell below 1.2 mA/g (corresponding to C/100) or 15 mA/g (corresponding to C/8). The cell was discharged by the cc (constant current) method with a constant current of 12 mA/g (corresponding to C/10) in the first cycle and of 60 mA/g (corresponding to C/2) in the subsequent cycles until attainment of the voltage limit of 2.5 V. The specific current chosen was based on the weight of the coating of the positive electrode. The ratio of charge to discharge capacity of the cell is referred to as the Coulomb efficiency. The electrodes were selected such that a cathode:anode capacitance ratio of 1:1.2 was established.

### Comparative Example 5: Excessive Removal of Excess Silicon by Etching with an Amount of Sodium Hydroxide Solution Tailored to the Coarse Silicon Content

0.4 g of NaOH in 99.8 ml of demineralized water was initially charged into a 250 ml round-bottom flask and 6.05 g of the material from Example 1 were added gradually. The suspension obtained was stirred at 40° C. in a water bath for 10 min and then passed through a paper filter (filter paper 413, VWR). The powder thus obtained was then suspended in 200 ml of water and isolated by filtration once again. This procedure was repeated until the filtrate obtained had a pH of 8.0. The resulting filter cake was dried to constant weight at 80° C. in a drying cabinet. The properties of the treated Si composite can be found in Table 1 (excess silicon 0.0% by weight. BET surface area 170 m²/g). The silicon content was 41.6% by weight. % by weight.

TABLE 1
Properties of the etched silicon-containing materials

| | | | | | | | Number of |
|---|---|---|---|---|---|---|---|
| | Silicon | | Oxygen | Excess | | Rev. spec. | cycles |
| | content | Surface | content | silicon | | anode capacity | with ≥80% |
| Example | [% by | area | [% by | [% by | Example no. | in the 2nd cycle | capacity |
| no. | weight](ICP) | BET [m²/g] | weight] (EA) | weight] | Electrochemistry | [mAh/g] | retention |
| 1* | 57.5 | 7 | 2.3 | 3.9 | 3* | 1152 | 69 |
| 2 | 48.0 | 64 | 13.2 | 0.0 | 4 | 774 | 349 |
| 5* | 41.6 | 170 | 18.6 | 0.0 | 6* | 650 | 278 |

*noninventive

1-13. (canceled)

14. A process for producing etched silicon-containing materials,
in which, in a first step, silicon is deposited in the pores and on the surface of porous particles, the porous particles having a specific surface area determined according to DIN 66131 of ≥100 m²/g, by way of thermal decomposition of silicon precursors on the porous particles, forming silicon-containing materials,
and, in a second step, some of the deposited silicon of the silicon-containing materials is removed by etching-off.

15. The process as claimed in claim 1, in which liquid or gaseous etching medium is used in the second step.

16. The process as claimed in claim 14, in which the etching-off is effected by wet-chemical treatment with basic solutions.

17. The process as claimed in claim 16, in which the basic solutions contain bases selected from KOH, tetramethylammonium hydroxide (TMAH), NaOH, LiOH, CsOH, NH₄OH, Mg(OH)₂, Ca(OH)₂, Ba(OH)₂, ethylenediamine (EDA).

18. The process as claimed in claim 14, in which, in the second step, some of the deposited silicon of the silicon-containing materials, which is referred to as coarse silicon, is removed by etching-off and the silicon referred to as fine silicon remains on the etched silicon-containing materials,
where, before the etching-off, the coarse silicon to be etched off is determined as follows:
the reactivity of the powders to oxygen is determined and calculated by TGA (thermogravimetry) measurements in pure oxygen in a temperature window of 25-1000° C. using a heating rate of 5 K/min, (mres) is the residual mass after carrying out the TGA (mdiff) is the mass difference resulting from the oxidation of the coarse silicon at temperatures of more than 700° C.,
using the molar mass of O₂ (32 g/mol) and the molar mass of SiO₂ (60.08 g/mol), the proportion of coarse silicon in the deposited silicon is calculated via the following formula:
$$coarse Si , \% = mdiff * \frac{60.08 \frac{g}{mol}}{32 \frac{g}{mol} * mres} * 100 \%$$
where silicon of the “coarse silicon” category shows a reaction in the TGA at temperatures of more than 700° C.

19. The process as claimed in claim 18, in which the amount of coarse silicon in the deposited silicon after the etching is less than 1% by weight.

20. The process as claimed in claim 14, in which, after the etching, the etched silicon-containing materials are washed with washing medium, separated from the washing medium and dried.

21. The process as claimed in claim 14, in which the surface area of the etched silicon-containing materials is less than 80 m²/g.

22. The process as claimed in claim 14, where amorphous carbons, silicon dioxide, boron nitride, silicon carbide and silicon nitride or else mixed materials based on these materials are used as porous particles.

23. Etched silicon-containing materials, produced by the process as claimed in claim 14.

24. An anode material containing an etched silicon-containing material as claimed in claim 23.

25. An anode comprising a current collector coated with an anode material as claimed in claim 24.

26. Lithium-ion batteries comprising a cathode, an anode as claimed in claim 25, two electrically conducting connections to the electrodes, a separator and an electrolyte with which the separator and the two electrodes are impregnated, and a housing accommodating the parts mentioned.
